(19) United States
(12) Patent Application Publication
(10) Pub. No.: US 2026/0037812 A1
(43) Pub. Date: Feb. 5, 2026

(54) POLICY GENERATING APPARATUS AND METHOD FOR SLM

(71) Applicant: RESEARCH & BUSINESS FOUNDATION SUNGKYUNKWAN UNIVERSITY, Suwon-si (KR)

(72) Inventors: Hong Uk WOO, Suwon-si (KR); Won Je CHOI, Suwon-si (KR); Woo Kyung KIM, Suwon-si (KR); Min Jong YOO, Suwon-si (KR)

(21) Appl. No.: 19/284,480

(22) Filed: Jul. 29, 2025

(30) Foreign Application Priority Data
Aug. 1, 2024 (KR) 10-2024-0102441

(51) Int. Cl. G06N 3/0895

(52) U.S. Cl. CPC G06N 3/0895

(57) ABSTRACT

It is about the policy generating apparatus and method for SLM, the policy generating method for SLM may comprise receiving an expert dataset, generating a rationale dataset based on the expert dataset and a pre-stored initial rationale set, verifying the rationale dataset through a self-verification function, learning a reasoning policy through an embodied knowledge graph based on the verified rationale dataset, learning a planning policy based on a rationale set of the learned reasoning policy and a planning policy reconstruction loss and generating an SLM policy including a final reasoning policy and a planning policy based on the learned reasoning policy and the planning policy.

### CROSS-REFERENCE TO RELATED APPLICATION

This application claims the priority benefit of Korean Patent Application No. 10-2024-0102441 filed on Aug. 1, 2024 in the Korean Intellectual Property Office, the disclosure of which is incorporated herein by reference.

### BACKGROUND 1. Field

The present invention relates to an apparatus and a method for generating a reasoning policy and a planning policy for SLM.

2. Description of the Related Art

With the commercialization of artificial intelligence, various studies are being conducted to derive policy based on expert datasets. In particular, since it is not easy to operate large language models (LLM) in a ready-made apparatus such as a portable terminal having low computing power, various studies for operating a small language model (SLM) have been conducted.

In addition, significant advances have been made in the application of LLM to task plans in AI. For example, research that interprets task instructions by combining LLM's reasoning ability with a reinforcement learning (RL)-based suitability model and derives robot technology that can be executed in the environment, and research that explores how to ground LLM to the environment through prompts based on sensory data, reference trajectories, and available technologies are actively being conducted. In addition, studies are underway to extend the specific reasoning ability of LLM to multimodal data such as visual observation.

However, such an approach may face realistic limitations in making short-term decisions by continuing to rely on LLM. This may be especially true when decision-making agents need to operate on commercial apparatus with limited capacity. The high computational requirements of LLM have important technical problems in these scenarios, and research to solve them is actively underway.

Direct end-to-end distillation of LLM into smaller, resource-efficient models may appear simple but may not be effective for complex specific tasks. Research to address this technical challenge requires a deep understanding of specific task functions, essentially because it requires long-term multi-level reasoning and the ability to adapt to changing environmental contexts over time. Specific agents frequently encounter new environmental information through interactions with their surroundings. Continuous exposure to these various environmental conditions adds complexity and volatility, complicating the distillation process, and the results of related research are slow.

### SUMMARY

This Summary is provided to introduce a selection of concepts in a simplified form that is further described below in the Detailed Description. This Summary is not intended to identify key features or essential features of the claimed subject matter, nor is it intended to be used as an aid in determining the scope of the claimed subject matter.

Provided are a policy generating apparatus and method for an SLM that generate a reasoning policy and a planning policy by generating and verifying a rationale dataset.

In one embodiment, a policy generating method for SLM may comprise receiving an expert dataset, generating a rationale dataset based on the expert dataset and a pre-stored initial rationale set, verifying the rationale dataset through a self-verification function, learning a reasoning policy through an embodied knowledge graph based on the verified rationale dataset, learning a planning policy based on a rationale set of the learned reasoning policy and a planning policy reconstruction loss and generating an SLM policy including a final reasoning policy and a planning policy based on the learned reasoning policy and the planning policy.

According to an embodiment, the learning a planning policy comprises generating the rationale set of the inferred reasoning policy based on a policy of an encoder based on an encoder prompt pool, a policy of a decoder based on a decoder prompt pool, and an attention module while performing the learning of the reasoning policy.

According to an embodiment, the encoder prompt pool comprises a prefix prompt and a postfix prompt.

According to an embodiment, the rationale set of the inferred reasoning policy is generated through rationale reconstruction loss based on a graph extracted through a rationale and a knowledge graph retriever function.

According to an embodiment, the rationale reconstruction loss is an equation

$${L}_{Rtn} = {𝔼}_{( o , h , R ) \sim {D}_{Rtn}} [ {\sum }_{i = 1}^{m} log {Φ}_{R} ( {r}_{i} \vert g ) ]$$

(where, L_{Rtn} rationale reconstruction loss, o: observation, h: task description, R: rationale set, g: graph extracted through knowledge graph retriever function).

According to an embodiment, the embodied knowledge graph is a prompted knowledge graph in the learning a reasoning policy.

According to an embodiment, the prompted knowledge graph is based on a batch sample including a positive pair, which is an embodied knowledge graph executing the same plan, and a negative pair, which is a continuous planning step.

According to an embodiment, the prompted knowledge graph is based on a contrastive learning loss, and the contrastive learning loss is an equation L_{Con}= [symbol] _{B}_{_{Con}}_{˜D}_{_{Rtn}}[max{0, d(\hat{z}, \hat{z}⁺)−d(\hat{z}, \hat{z}⁻)+ϵ}] (where, L_{Con}: contrastive learning loss, B_{Con}: batch sample, \hat{z}: embedding space, d: sum of distance metrics corresponding to elements of each rationale embedding sequence within embedding space \hat{z}∈Z, and ϵ: margin parameter).

According to an embodiment, the planning policy is learned by predicting a next plan (a) based on the rationale set of the learned reasoning policy in the learning a planning policy, and learned through an equation Φ_{P}=(R=Φ_{R}(g))→a (where, Φ_{P}: planning policy, R: rationale set of reasoning policy, Φ_{R}: reasoning policy, g: graph extracted through knowledge graph retriever function, a: next plan).

According to an embodiment, the planning policy reconstruction loss is an equation L_{Plan}= [symbol] _{(o,h,R)˜D}_{_{Rtn}}_{,R˜Φ}_{_{R}}[logΦ_{P}(a|R)] (where, L_{Plan}: planning policy reconstruction loss, o: observation, h: task description, R: rationale set, Φ_{P}: planning policy, a: next plan).

In one embodiment, a policy generating apparatus for SLM may comprise an input/output interface configured to receive an expert dataset, a processor configured to generate an SLM policy based on the expert dataset and a communicator configured to transmit the generated SLM policy to a terminal, wherein the processor is configured to generate a rationale dataset based on the expert dataset and a pre-stored initial rationale set, verify the rationale dataset through a self-verification function; learn a reasoning policy through an embodied knowledge graph based on the verified rationale dataset; learn a planning policy based on a rationale set of the learned reasoning policy and a planning policy reconstruction loss; and generate an SLM policy including a final reasoning policy and a planning policy based on the learned reasoning policy and the planning policy.

According to an embodiment, the processor is further configured to, when learning the planning policy, generate the rationale set of the inferred reasoning policy based on a policy of an encoder based on an encoder prompt pool, a policy of a decoder based on a decoder prompt pool, and an attention module while performing the learning of the reasoning policy, and wherein the encoder prompt pool comprises a prefix prompt and a postfix prompt.

According to an embodiment, the processor is further configured to generate the rationale set of the inferred reasoning policy through rationale reconstruction loss based on a graph extracted through a rationale and a knowledge graph retriever function. According to an embodiment, the rationale reconstruction loss is an equation

$${L}_{R t n} = {𝔼}_{( o , h , R ) \sim {D}_{R m}} [ {\sum }_{i = 1}^{m} log {Φ}_{R} ( {r}_{i} \vert g ) ]$$

(where, L_{Rtn} rationale reconstruction loss, o: observation, h: task description, R: rationale set, g: graph extracted through knowledge graph retriever function).

According to an embodiment, the embodied knowledge graph is a prompted knowledge graph in the learning a reasoning policy.

According to an embodiment, the prompted knowledge graph is based on a batch sample including a positive pair, which is an embodied knowledge graph executing the same plan, and a negative pair, which is a continuous planning step.

According to an embodiment, the prompted knowledge graph is based on a contrastive learning loss, and the contrastive learning loss is an equation L_{Con}= [symbol] _{B}_{_{Con}}_{˜D}_{_{Rtn}}[max{0, d(\hat{z}, \hat{z}⁺)−d(\hat{z}, \hat{z}⁻)+ϵ}] (where, L_{Con}: contrastive learning loss, B_{Con}: batch sample, \hat{z}: embedding space, d: sum of distance metrics corresponding to elements of each rationale embedding sequence within embedding space \hat{z}∈Z, and ϵ: margin parameter).

According to an embodiment, the planning policy is learned by predicting a next plan (a) based on the rationale set of the learned reasoning policy in the learning a planning policy, and learned through an equation Φ_{P}=(R=Φ_{R}(g))→a (where, Φ_{P}: planning policy, R: rationale set of reasoning policy, Φ_{R}: reasoning policy, g: graph extracted through knowledge graph retriever function, a: next plan).

According to an embodiment, the planning policy reconstruction loss is an equation L_{Plan}= [symbol] _{(o,h,R)˜D}_{_{Rtn}}_{,R˜Φ}_{_{R}}[logΦ_{P}(a|R)] (where, L_{Plan}: planning policy reconstruction loss, o: observation, h: task description, R: rationale set, Φ_{P}: planning policy, a: next plan).

In one embodiment, a central server for generating a policy for an SLM may comprise an input/output interface configured to receive an expert dataset, a processor configured to generate an SLM policy based on the expert dataset and a communicator configured to transmit the generated SLM policy to a terminal, wherein the processor is configured to generate a rationale dataset based on the expert dataset and a pre-stored initial rationale set, verify the rationale dataset through a self-verification function; learn a reasoning policy through an embodied knowledge graph based on the verified rationale dataset; learn a planning policy based on a rationale set of the learned reasoning policy and a planning policy reconstruction loss; and generate an SLM policy including a final reasoning policy and a planning policy based on the learned reasoning policy and the planning policy.

According to the above-described policy generating apparatus and method for an SLM, it is possible to learn and generate a reasoning policy and a planning policy by generating and verifying a rationale dataset based on an expert dataset and a rationale set.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a block diagram of a policy generating apparatus for SLM according to an embodiment.

FIG. 2 is a block diagram of a central server according to an embodiment.

FIGS. 3A, 3B, 3C, 3D, and 3E are block diagrams of a processor and an input/output interface according to an embodiment.

FIGS. 4A, 4B, 4C, 4D, and 4E are block diagrams of a processor and an input/output interface according to another embodiment.

FIG. 5 is a conceptual diagram of the relationship between a query and a rationale according to an embodiment.

FIG. 6 is a conceptual diagram of a policy learning algorithm according to an embodiment.

FIG. 7 is a flowchart of a policy generating method for SLM according to an embodiment.

FIG. 8 is a flowchart of a method of generating a policy for SLM according to another embodiment.

FIG. 9 is a flowchart of a method of generating a policy for SLM according to another embodiment.

Throughout the drawings and the detailed description, the same reference numerals may refer to the same, or like, elements. The drawings may not be to scale, and the relative size, proportions, and depiction of elements in the drawings may be exaggerated for clarity, illustration, and convenience.

### DETAILED DESCRIPTION

The advantages and features of the present disclosure, and the manner in which they are achieved, will be more clearly understood from the following detailed description of exemplary embodiments with reference to the accompanying drawings. However, it should be understood that the present disclosure is not limited to the specific embodiments disclosed herein, but may be embodied in various other forms. Rather, the embodiments are provided so that this disclosure will be thorough and complete, and will fully convey the scope of the invention to those skilled in the art. The scope of the invention is defined only by the appended claims.

The following provides a brief explanation of the terms used in this specification, followed by a detailed description of the present disclosure.

The terminology used in the present invention has been selected to reflect functions of the invention and, where possible, employs commonly used terms that are widely accepted in the art. However, such terminology may vary depending on the intent of a practitioner in the field, judicial precedents, or the emergence of new technologies. In certain cases, terms may be arbitrarily defined by the applicant, in which case their meanings will be clearly stated in the relevant parts of the specification. Accordingly, the terms used herein should not be interpreted merely based on their names or labels, but should be understood in light of their intended meanings and the overall context of the present invention.

Throughout this specification, when a component is described as “including” or “comprising” another component, it is to be understood that, unless expressly stated otherwise, the component may include additional components, and is not limited to the specifically recited ones. As used in the specification, the terms such as “part,” “module,” or “unit” refer to a functional element that performs one or more functions or operations. These elements may be implemented as software, hardware (such as FPGA or ASIC), or a combination of both. However, the use of these terms does not imply a limitation to software or hardware only. These components may be embodied in computer-readable storage media or configured to be executed by one or more processors. Accordingly, the terms “part,” “module,” or “unit” may encompass software components, object-oriented software components, class components, task components, processes, functions, attributes, procedures, subroutines, program code segments, drivers, firmware, microcode, circuits, data, databases, data structures, tables, arrays, and variables.

Hereinafter, exemplary embodiments of the present invention will be described in detail with reference to the accompanying drawings so that those skilled in the art may readily implement the invention. In the drawings, parts not directly relevant to the description of the invention are omitted for clarity of illustration.

The terms such as “first,” “second,” and the like may be used to describe various elements, but such terms are merely used to distinguish one element from another and do not imply any limitation on the elements themselves. For example, without departing from the scope of the present invention, a “first” component may be referred to as a “second” component, and similarly, a “second” component may be referred to as a “first” component. The term “and/or” as used herein includes any and all combinations of one or more of the associated listed items, as well as any of the individual items.

Hereinafter, an embodiment of a policy generating method for an SLM, a policy generating apparatus for an SLM, and a central server for generating a policy for SLM will be described with reference to the accompanying drawings.

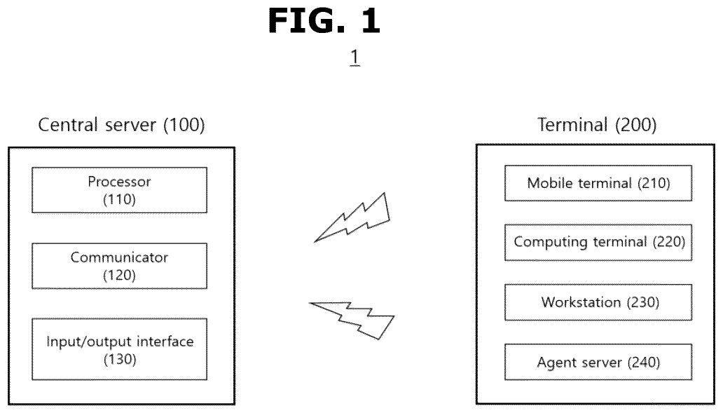

Hereinafter, an embodiment of a policy generating apparatus for an SLM and a central server for generating policy for an SLM will be described with reference to FIGS. 1 to 6.

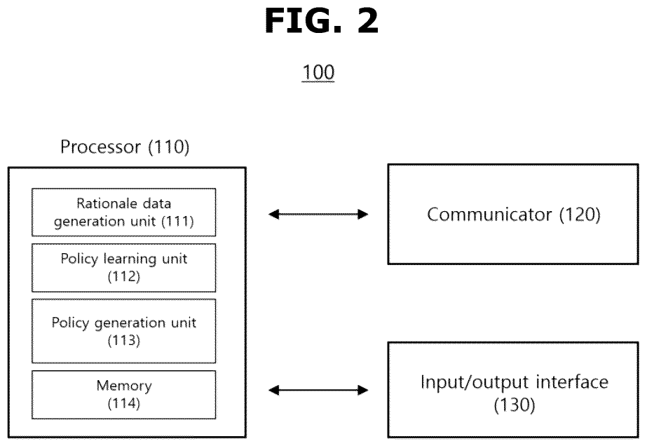

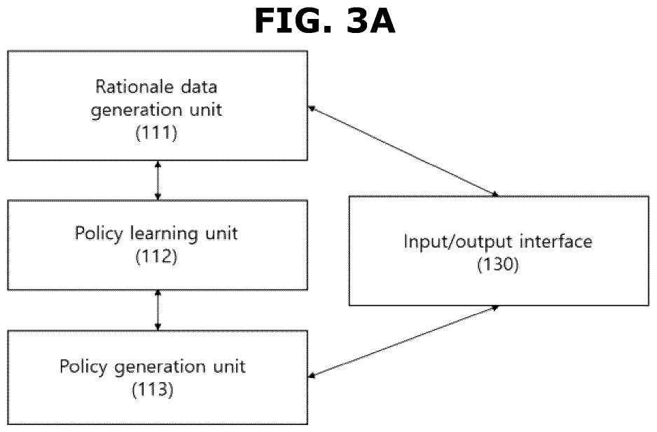

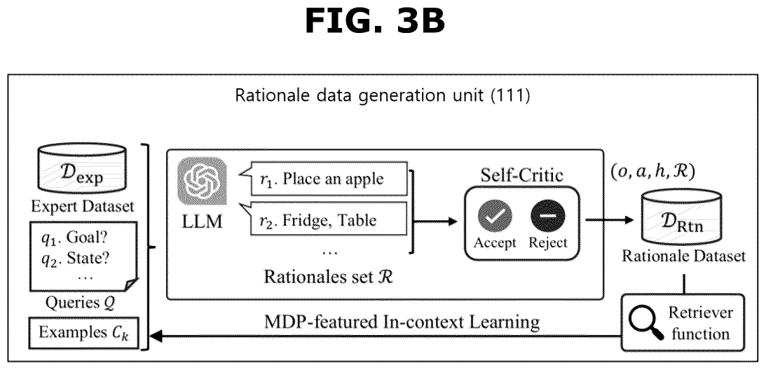

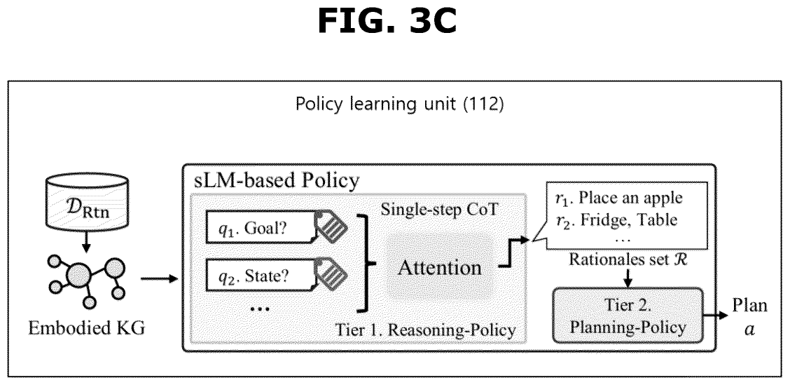

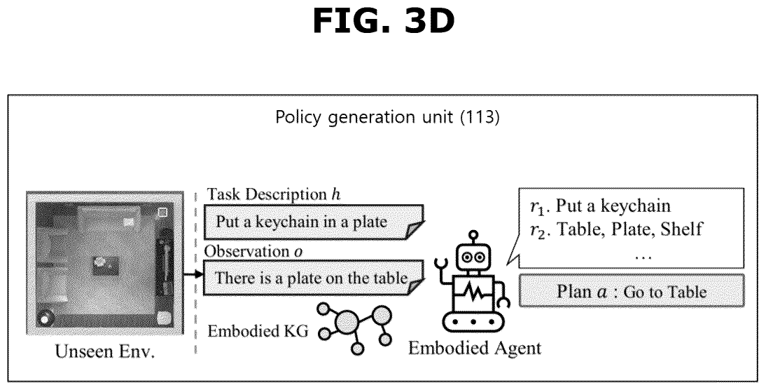

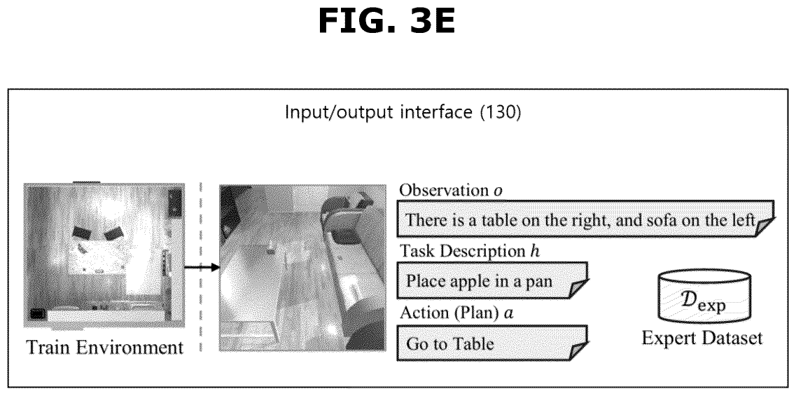

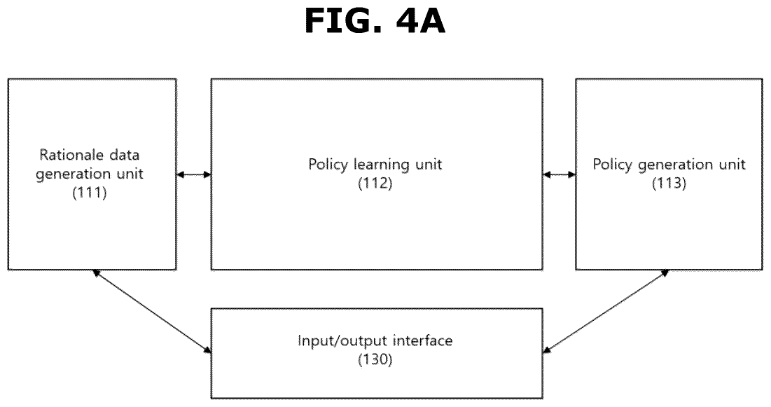

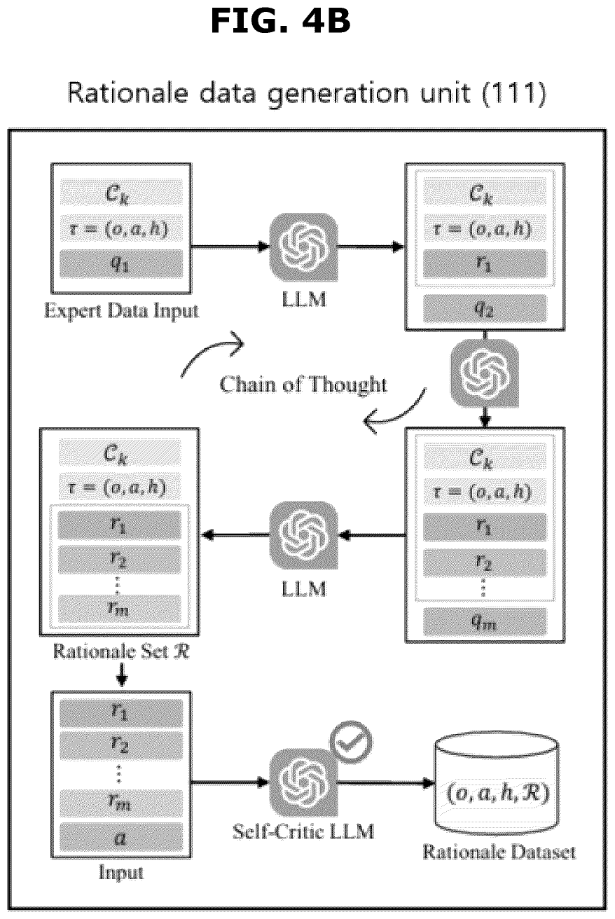

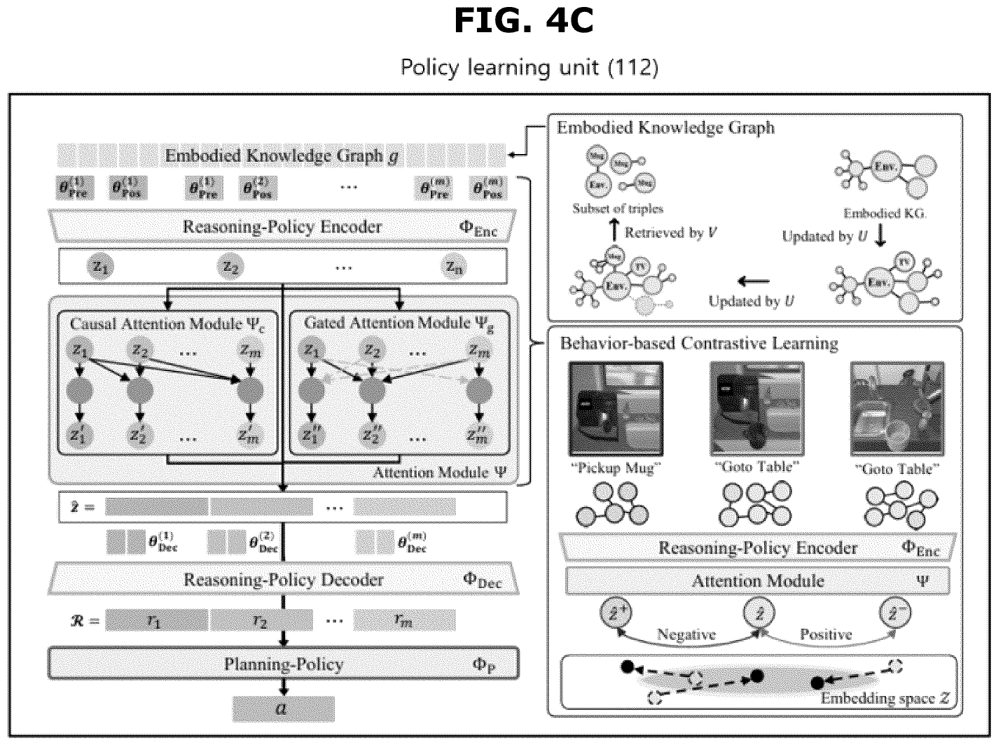

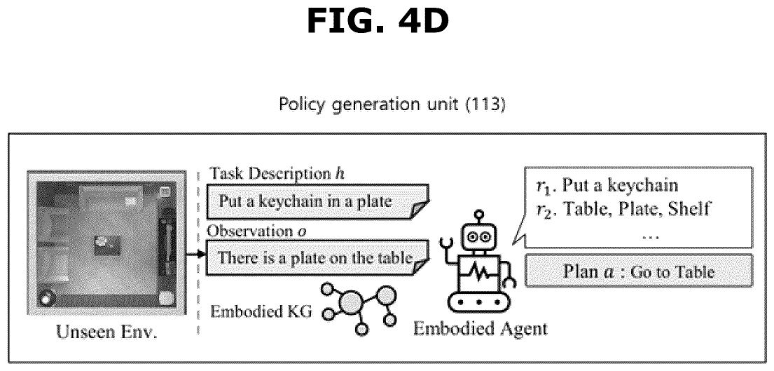

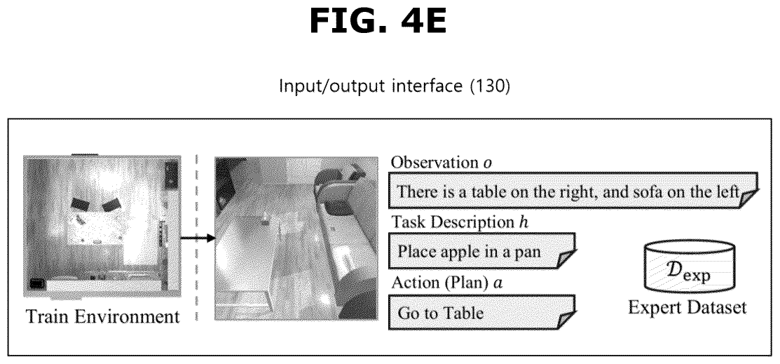

FIG. 1 is a block diagram of a policy generating apparatus 1 for SLM according to an embodiment, FIG. 2 is a block diagram of a central server according to an embodiment, FIGS. 3A, 3B, 3C, 3D, and 3E are block diagrams of a processor 110 and an input/output interface 130 according to an embodiment, and FIGS. 4A, 4B, 4C, 4D, and 4E are block diagrams of a processor 110 and an input/output interface 130 according to another embodiment.

Referring to FIG. 1, the policy generating apparatus 1 for SLM may include a central server 100 and a terminal 200.

The terminal 200 may receive an expert dataset for generating an SLM policy from a user, and the terminal 200 may include a mobile terminal 210, a computing terminal 220, a workstation 230, and an agent server 240.

The central server 100 may generate a rationale dataset based on the expert dataset and the pre-stored initial rationale set, and verify the generated rationale dataset through a self-verification function. The central server 100 may learn the reasoning policy through the Knowledge Graph (KG) embodied based on the verified rationale dataset, and learn the planning policy based on the rationale set of the learned reasoning policy and a planning policy reconstruction loss. The central server 100 may generate an SLM policy including a final reasoning policy and a planning policy based on the learned reasoning policy and the planning policy.

The policy generating apparatus 1 and the central server 100 for SLM of the present disclosure may minimize divergence of large language models (LLM)-based policy distillation from the distribution of the policy LLM, and may explore a unique two-step hierarchical structure in the decomposition and distillation of the reasoning ability of the LLM.

The environment of the agent embodied in the reinforcement learning (RL) is modeled as a Partially Observable Markov Decision Process, POMDP, which may be represented as a tuple of (S, A, P, G, H, R, Ω, O). where s∈S is the state space, a∈A is the action space, P:S×A×S→[0, 1] is the transition probability, G∈G is the target space, h∈H is the high-level task description, and R:S×A×G→R is the reward function.

A distinct aspect of the environment of the embodied agent lies in the nature of the partial observation, which may be characterized by the observation space of the o∈Ω and the conditional observation probability O:S×A→Ω. This explains the agent's limited perception, which can complicate decision-making and reflect the real-world situation.

The present disclosure may achieve a strong small language model (SLM)-based policy Φ*_{sLM} that may be used in a commercial apparatus having a limited capacity such as the terminal 200. This may be similar to the performance shown in the task plan in which the LLM-based policy Φ_{LLM} is embodied. The SLM policy may include a final reasoning policy and a planning policy, and the SLM policy Φ*_{sLM} may be derived by Equation 1.

$${Φ}_{s L M}^{*} = arg {max}_{{Φ}_{s L M}} 𝔼 [ {\sum }_{t = 0}^{∞} {γ}^{t} R ( {s}_{t} , {Φ}_{s L M} ( {o}_{t} , {h}_{t} ) , G ) - D ( {Φ}_{L L M} ( {o}_{t} , {h}_{t} ) , {Φ}_{s L M} ( {o}_{t} , {h}_{t} ) ) ] \qquad [ Equation 1 ]$$

Here, D is a distance function such as Kullback-Leibler divergence, and γ is a discount factor of the environment.

For embodied task, it is important for agents to have the ability to understand and interact with complex and dynamic environments. However, when using SLM-based policy, it is necessary to simplify the reasoning process due to the limited capacity of the model. This can be achieved by integrating MDP functions specified by reinforcement learning (RL) formulas such as goals, states, observations, actions, remaining rewards, and sub-goals into the reasoning process.

The policy generating apparatus 1 and the central server 100 for SLM of the present disclosure refer to this type of environmental information and MDP functions as rationale, which may act as justification or hints to help explain the reasoning behind the plan. The policy generating apparatus 1 and the central server 100 for SLM may achieve the LLM-based policy by effectively distilling the embodied reasoning ability of the SLM into a small model using this rationale. The present disclosure relates to a framework for a policy for SLM, which 1) constructs and verifies a rationale dataset, 2) learns (distills) and generates an SLM policy—comprising a reasoning policy and a planning policy—via an embodied knowledge graph (Embodied KG), and 3) enables evaluation of the SLM policy in previously unseen environments through zero-shot deployment.

Specifically, in the rationale dataset construction (generation and verification) phase, a Chain-of-Thought prompting (CoT) scheme can be utilized to extract rationales from expert dataset transitions (e.g., a sequence of action plans) in the environment using an LLM. This is achieved by using RL-specific queries as prompts through in-context learning with Markov Decision Process (MDP) functions. In the next phase, the distillation of SLM policy (reasoning policy and planning policy), a two-level hierarchical SLM-based policy based on the embodied knowledge graph is established. This includes a reasoning policy trained to generate rationales through a single-step CoT optimized via behavior-based contrastive learning, and a learned planning policy that infers action plans using these rationales as guidance through CoT prompts. In the zero-shot deployment phase, the distilled SLM policy in a new environment in which the task description, object location, and indoor scene are changed may be evaluated in a zero-shot method.

In embodied task, it is essential for agents to have the ability to understand and interact with complex and dynamic environments. However, it is particularly necessary to simplify the reasoning process due to the limitation of model capacities when using SLM-based policy. This can be achieved by integrating MDP features—such as goals, states, observations, actions, remaining rewards, and sub-goals—specified in the reinforcement learning (RL) formulation into the reasoning process. In the present disclosure, such environmental information and MDP features are defined as rationale, which may act as justification or hints to help explain the reasoning behind the plan. The present disclosure achieves an SLM-based policy by effectively distilling the embodied reasoning ability of LLM into a small model using this rationale.

The central server 100 may include a processor 110, a communicator 120, and an input/output interface 130.

The communicator 120 may receive the user's input expert dataset from the terminal 200. The communicator 120 may be implemented using, for example, at least one communication module (e.g., a LAN card, a short-range communication module, a mobile communication module, or the like).

The input/output interface 130 may provide the user to directly input the expert dataset to the central server 100 without the communicator 120 receiving the expert dataset from the terminal 200. The input/output interface 130 may include an input unit and an output unit.

The input/output interface 130 may be in the form of pressing a manipulation button in the form of a push button, may manipulate the operation of the policy generating apparatus 1 for the SLM desired by the user and the central server 100 for generating the policy for the SLM, such as a slide switch, or may input the operation desired by the user in the form of a touch. In addition, various types of input apparatus for inputting the operation of the policy generating apparatus 1 for the SLM and the central server 100 for generating the policy for the SLM desired by the user may be used as an example of the input unit.

For example, the input/output interface 130 may include a display. The display may be a Cathode Ray Tube (CRT), a Digital Light Processing (DLP) panel, a plasma display panel, a Liquid Crystal Display (LCD) panel, an Electro Luminescence (EL) panel, an Electrophoretic Display (EPD) panel, an Electrochromic Display (ECD) panel, a Light Emitting Diode (LED) panel, or an Organic Light Emitting Diode (OLED) panel, but is not limited thereto. In addition, the output unit may include a Central Processing Unit (CPU), a Graphic Processing Unit (GPU), and various types of storage apparatus implemented as a microprocessor, and such apparatus may be provided on a Printed Circuit Board (PCB) embedded therein.

The processor 110 may generate a rationale dataset based on the expert dataset and the pre-stored initial rationale set, and verify the generated rationale dataset through a self-verification function. The central server 100 may learn the reasoning policy through the Knowledge Graph (KG) embodied based on the verified rationale dataset, and learn the planning policy based on the rationale set of the learned reasoning policy and the planning policy reconstruction loss. The central server 100 may generate an SLM policy including a final reasoning policy and a planning policy based on the learned reasoning policy and the planning policy.

The processor 110 may include, for example, a Central Processing Unit (CPU), a Graphic Processing Unit (GPU), a Micro Controller Unit (MCU), an Application Processor (AP), a Electronic Controlling Unit (ECU), and/or at least one electronic apparatus capable of performing various operations and control processing. These apparatus may be implemented, for example, by using one or two or more semiconductor chips, circuits, or related components alone or in combination.

The processor 110 may include a rationale data generation unit 111, a policy learning unit 112, a policy generation unit 113, and a memory 114.

The rationale data generation unit 111 may generate a rationale dataset based on an expert dataset and a pre-stored initial rationale set. The rationale data generation unit 111 may verify whether the generated rationale dataset matches the action plan by using LLM as a self-verification function.

Specifically, the rationale data generation unit 111 may receive an expert dataset Dₑₓₚ={τᵢ=(oᵢ, aᵢ, hᵢ)}ᵢ. τᵢ means each transition, oᵢ means observation, aᵢ means action (plan), and hi means high-level task description. The rationale data generation unit 111 may generate a rationale dataset D_{Rtn}={cᵢ=(oᵢ, aᵢ, hᵢ, Rᵢ)}ᵢ by expanding the expert dataset Dₑₓₚ. Here, each transition τᵢ can be supplemented by a rationale set

$$R = {\{ {r}_{j} \}}_{j = 1}^{m} .$$

In order to obtain a set of rationale configured for a given embodying operation, the rationale data generation unit 111 integrates in-context learning with MDP functions and CoT prompt mechanisms. This can be performed iteratively using a series of RL specific queries of the LLM as prompts. After that, the rationale set D_{Rtn} is integrated into the rationale dataset after evaluation by LLM.

The rationale data generation unit 111 may perform in-context learning having an MDP feature. Specifically, the rationale data generation unit 111 may perform in-context learning of continuously updating the example in the rationale dataset in order to extract the rationale from the LLM using the transition τ. The rationale data generation unit 111 may use a retriever function F:(τ, C)→Cₖ. The rationale data generation unit 111 may obtain an example set Cₖ by receiving a transition τ in an expert dataset and a tuple set C={c₁, . . . , cₙ} in the rationale dataset as inputs using a search function, and searching the C for the top k tuples most semantically related to the given τ. Semantic relevance may be calculated as an inner product between transition τ and c through a pre-trained language embedding model E. That is, the relevance score may be obtained as S(τ, c)=E(τ)^{T} E(c).

The rationale data generation unit 111 may sequentially generate a rationale set as shown in Equation 2 by providing a prompt to the LLM policy Φ_{LLM} together with a predefined series of RL-specific queries Q={q₁, . . . , qₘ} using an example set.

$$R = \{ {r}_{l} \vert {r}_{l} = {Φ}_{L L M} ( {C}_{k} , τ , {\{ {r}_{j} \}}_{j < l} , {q}_{l} ) \} \qquad [ Equation 2 ]$$

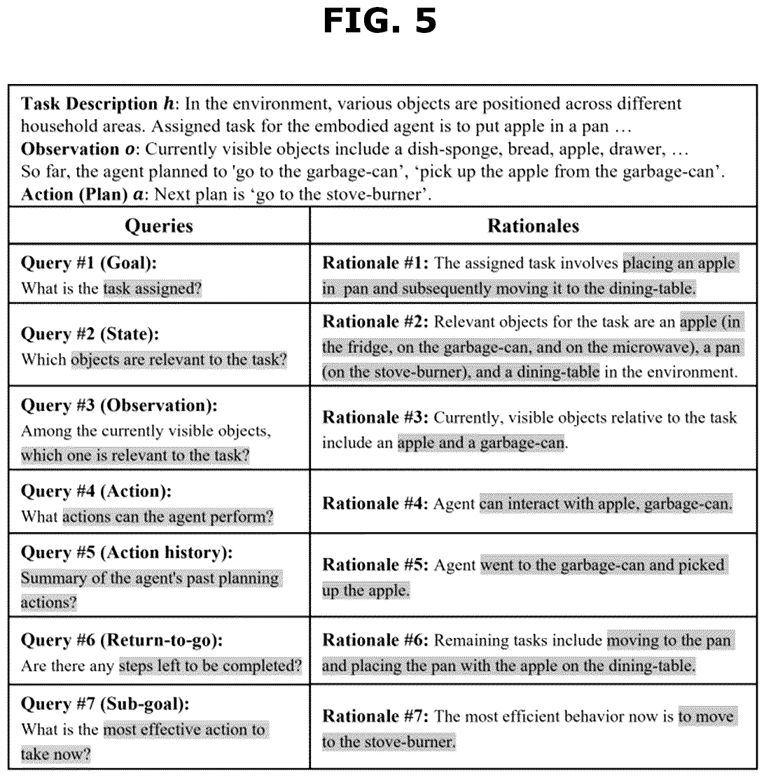

Here, {rⱼ}_{j<l} represents a rationale set generated before rₗ. In this process, Cₖ improves the in-context learning of LLM so that it can effectively respond to the query qₗ. In particular, the RL-specific query may extract the MDP features needed for a materialized task plan, such as goals, states, plans, observations, planning history, and sub-goals. An example of such a query and rationale is shown in FIG. 5.

The rationale data generation unit 111 may verify the rationale dataset by using LLM as a self-critique function. Specifically, the rationale data generation unit 111 uses LLM as a self-critique function to ensure that the rationale set R matches the action plan a. The rationale data generation unit 111 uses a query q_{cri} to check whether the plan a may be derived only by the rationale set by providing a prompt to the LLM. When the rationale set does not provide sufficient information on the plan, the rationale data generation unit 111 may start again from searching for an in-context example. Otherwise, the rationale data generation unit 111 may integrate the newly generated tuple c=(o, a, h, R) into the rationale dataset. The rationale data generation unit 111 may collect rationale including sufficient information to induce a plan in expert transition through self-verification. An operation in which the rationale data generation unit 111 verifies the rationale dataset is shown in Equation 3.

$${D}_{R t n} = \{ {c}_{i} \vert {Φ}_{L L M} ( {q}_{c r i} , {R}_{i} , {a}_{i} ) = 1 , {c}_{i} ∈ {D}_{R t n} \} \qquad [ Equation 3 ]$$

The policy learning unit 112 may generate and learn (distil) a reasoning policy and a planning policy through the embodied knowledge graph based on the verified rationale dataset.

The policy training unit 112 configures the policy in a two-step hierarchical structure in order to distil the LLM reasoning ability into the SLM-based policy Φ_{sLM} using the rationale dataset. The first stage is the reasoning policy Φ_{R}, which infers a rationale set from the given observation o, task description h, and embodied knowledge graph g. The second stage is the planning policy Φ_{P}, which generates a planning policy based on the rationales produced by the reasoning policy. The distillation process of the SLM-based policy is represented by Equation 4.

$${Φ}_{s L M} = {Φ}_{P} ∘ {Φ}_{R} : ( o , h ; g ) \to a \qquad [ Equation 4 ]$$

The embodied knowledge graph is an internal component of SLM-based policy that encapsulates environmental information. In the learning course, fine-tuning using soft prompts can be used to adopt SLM-based policy. This is effective in adopting SLM with limited reasoning ability.

It is important to express the information efficiently and prompt for SLM-based policy because the agent can continuously interact with the environment and accumulate information for completing the task. The policy learning unit 112 includes a triplet set

$$g = {\{ {x}_{i} = ( {x}_{i}^{s} , {x}_{i}^{r} , {x}_{i}^{o} ) \}}_{i}$$

using the embodied knowledge graph. Here,

$${x}_{i}^{s}$$

means a subject, xᵢ^{r} means a relationship, and

$${x}_{i}^{o}$$

means an object. For example, “the apple is on the table” and “the agent picks up the knife” are expressed as triplet terms of “Apple-On-Table” and “Agent-Pickup-Knife”. The policy learning unit 112 updates the embodied knowledge graph as shown in Equation 5 through the update function U in each planning step t.

$$U : ( {g}_{t - 1} , {a}_{t - 1} , {o}_{t} ) \to {g}_{t} \qquad [ Equation 5 ]$$

In order to prompt the SLM-based policy, the policy learning unit 112 may use the knowledge graph retriever function V searched for in the triplet g related to the observation o and the task description h as shown in Equation 6

$$V : ( o , h ; g ) \to \{ x ∈ g \vert S ( x , ( h , o ) ) \geq δ \} \qquad [ Equation 6 ]$$

The related triplet is selected by a pre-trained semantic relevance function S between each triplet and the observation and task description, where δis the threshold hyperparameter, and g is the graph extracted through the knowledge graph retriever function.

In relation to the distillation of the reasoning policy, the reasoning policy Φ_{R} may generate a rationale set from the given observation δ, task description h, and embodied knowledge graph g as shown in Equation 7. The data learning unit uses an encoder-decoder architecture and an attention module.

$${Φ}_{R} = {Φ}_{Dec} ∘ Ψ ∘ {Φ}_{E n c} : g \to R \qquad [ Equation 7 ]$$

In order to generate a rationale through a single step CoT, the data learning unit uses a soft prompt pool θ=[θ⁽¹⁾, θ⁽²⁾, . . . , θ^{(m)}], θ⁽ⁱ⁾∈R^{d}. The encoder policy Φ_{Enc} may include two prompt pools, a prefix prompt θ_{Pre} and a postfix prompt θ_{Pos}, and may be derived as shown in Equation 8.

$${Φ}_{E n c} : ( g ; {θ}_{Pre} , {θ}_{{p}_{o s}} ) \to z = [ {z}_{1} , … , {z}_{d} ] \qquad [ Equation 8 ]$$

Each prefix prompt

$${θ}_{pre}^{( i )}$$

is initialized based on the language embedding of the query qᵢ, and each postfix prompt

$${θ}_{P o s}^{( i )}$$

is initialized randomly. In addition, in order to emphasize information in each rationale and sequentially deliver the information in a manner consistent with the construction of the rationale dataset, the attention module Ψ may include a causal attention Ψ_{c} and a gate attention Ψ_{g} as shown in Equation 9.

$$\hat{z} = [ {\hat{z}}_{1} , … , {\hat{z}}_{d} ] = Ψ ( z ) = z + α ( {Ψ}_{c} ( z ) + {Ψ}_{g} ( z ) ) \qquad [ Equation 9 ]$$

Here, α is a scaling factor that controls the output of the attention mechanism. The decoder policy Φ_{Dec} may generate the rationale set R using the decoder prompt pool θ_{Dec} as shown in Equation 10.

$${Φ}_{D e c} : ( \hat{z} ; {θ}_{D e c} ) \to R \qquad [ Equation 10 ]$$

The data learning unit may optimize the reasoning policy through the rationale reconstruction loss together with the embodied knowledge graph generated in the rationale dataset D_{Rtn} through the update function U and the knowledge graph retriever function V as shown in Equation 11.

$${ℒ}_{R t n} = {𝔼}_{( o , h , R ) \sim {D}_{Rtn}} [ {\sum }_{i = 1}^{m} log {Φ}_{R} ( {r}_{i} \vert g ) ] \qquad [ Equation 11 ]$$

This loss is calculated by summing the log-likelihood of the probability to generate each rationale rᵢ.

Considering that minute changes in the environment may have inconsistent effects on the agent's plan, the data learning unit may include a prompted knowledge graph representation for causal and gate attention using behavior-based contrastive learning. The prompted knowledge graph representation enables single-step reasoning of multiple rationales through a rationale policy. The data learning unit samples the batch sample B_{Con}={(gᵢ, gᵢ⁺), (gᵢ, gᵢ⁻)}. Here, (gᵢ, gᵢ⁺) denotes a positive pair, and (gᵢ, gᵢ⁻) denotes a negative pair. Specifically, a positive pair is composed of an embodied knowledge graph executing the same plan, and a negative pair is defined as a continuous planning step. Thereafter, the contrastive learning loss may be calculated as shown in Equation 12.

$${ℒ}_{C o n} = {𝔼}_{{B}_{C o n} \sim {D}_{Rtn}} [ max \{ 0 , d ( \hat{z} , {\hat{z}}^{+} ) - d ( \hat{z} , {\hat{z}}^{-} ) + ϵ \} ] \qquad [ Equation 12 ]$$

Here, \hat{z}=Ψ∘Φ_{Enc}(g; θ_{Pre}, θ_{Pos}), d means the sum of distance metrics corresponding to elements of each basis embedding sequence in embedding space \hat{z}∈ [symbol] , and ϵ means a margin parameter.

The data learning unit may distil the planning policy. The planning policy Φ_{P} predicts the next plan a as shown in Equation 13 based on the set of rationale generated in the reasoning policy Φ_{R}.

$${Φ}_{P} = ( R = {Φ}_{R} ( g ) ) \to a \qquad [ Equation 13 ]$$

The data learning unit may optimize the planning policy through the reconstruction loss as shown in Equation 14.

$${ℒ}_{P l a n} = {𝔼}_{( 0 , h , R ) \sim {D}_{Rtn} , R \sim {Φ}_{R}} [ log {Φ}_{P} ( a \vert R ) ] \qquad [ Equation 14 ]$$

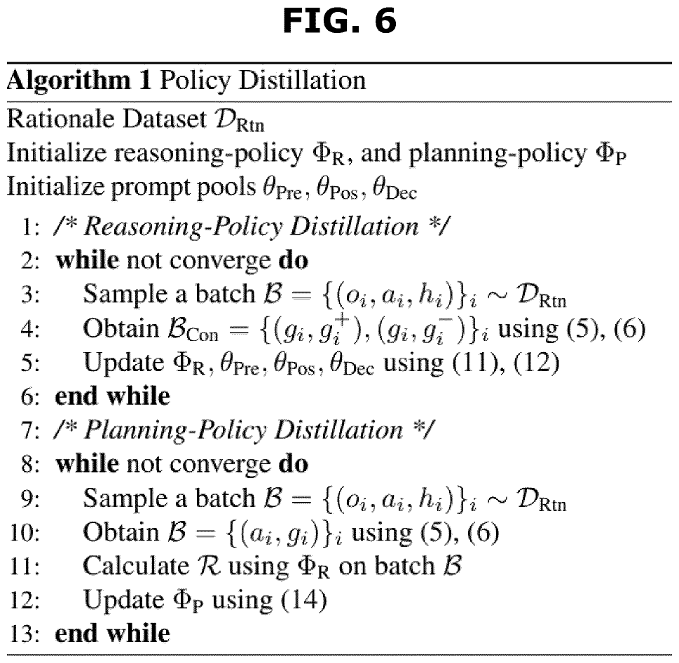

The data learning unit performs a policy distillation procedure with the algorithm as shown in FIG. 6, wherein the losses of (11), (12), and (14) are used for the reasoning policy and the planning policy, respectively.

The policy generation unit 113 may generate an SLM policy including a final reasoning policy and a planning policy based on the reasoning policy and the planning policy learned by the policy learning unit 112.

The memory 114 may store data necessary for an operation in the policy generating apparatus for an SLM. The memory 114 may store an expert dataset, a pre-stored initial dataset, a rationale dataset of reasoning policy, a self-verification function, a generated and verified dataset, an embodied knowledge graph, a prompt knowledge graph, learned reasoning policy data, a planning policy reconstruction loss, a rationale reconstruction loss, a contrastive learning loss, a final reasoning policy, and a final planning policy.

The memory 114 may include at least one of a main memory apparatus and an auxiliary memory apparatus. For example, the main memory apparatus may be implemented using a semiconductor storage medium such as a ROM and/or a RAM, and the auxiliary memory apparatus may be implemented based on an apparatus capable of permanently or semi-permanently storing data, such as a flash memory apparatus (a SSD (Solid State Drive)), a Secure Digital (SD) card, a HDD (Hard Disc Drive), a compact disk, a DVD, or a laser disk.

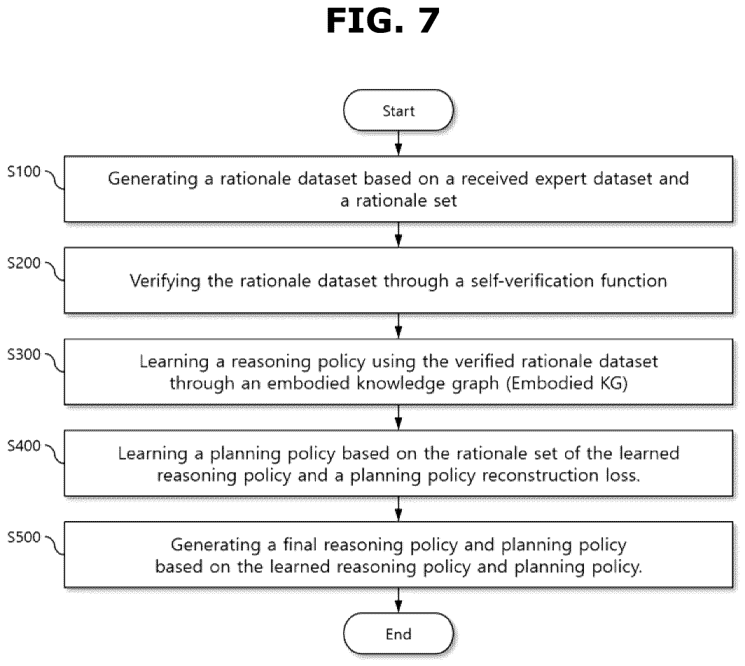

Hereinafter, an embodiment of a policy generating method for SLM will be described with reference to FIGS. 7 to 9.

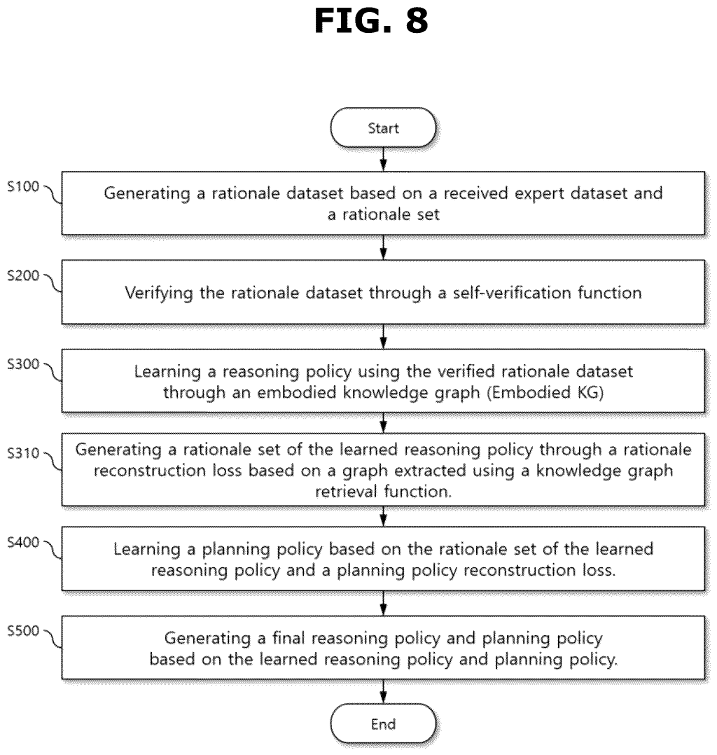

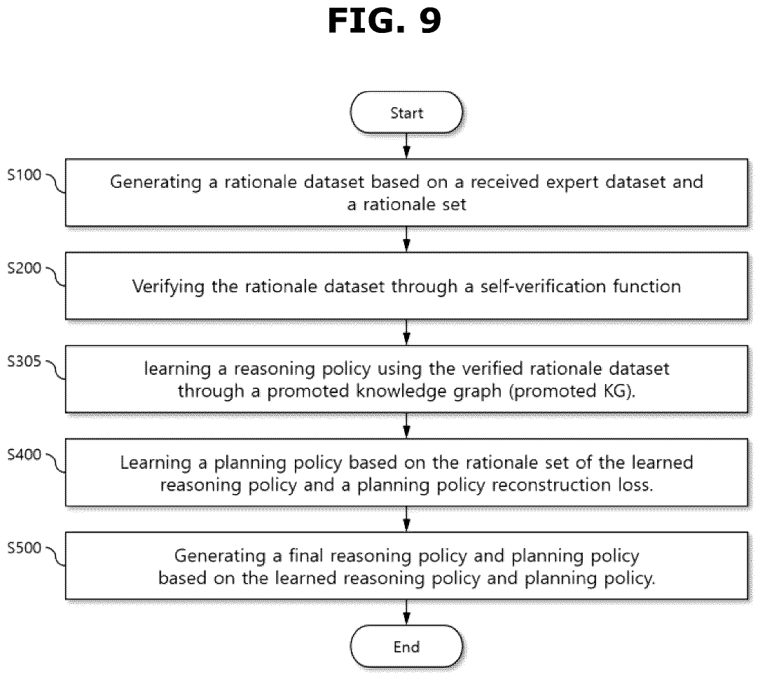

FIG. 7 is a flowchart of a policy generating method for SLM according to an embodiment, FIG. 8 is a flowchart of a method of generating a policy for SLM according to another embodiment, and FIG. 9 is a flowchart of a method of generating a policy for SLM according to another embodiment.

According to an embodiment of the policy generating method for SLM, the processor may generate a rationale dataset based on the first received expert dataset and a pre-stored initial rationale set (S100), and verify the rationale dataset through a self-verification function (S200). A reasoning policy may be learned through an embodied knowledge graph (S300) of the rationale dataset verified by the processor, and a planning policy may be learned based on the rationale set of the learned reasoning policy and the planning policy reconstruction loss (S400). Thereafter, the SLM policy including the final reasoning policy and the planning policy may be generated based on the reasoning policy and the planning policy learned by the processor (S500).

According to another embodiment of the policy generating method for SLM, the processor may generate a rationale dataset based on the first received expert dataset and a pre-stored initial rationale set (S100), and verify the rationale dataset through a self-verification function (S200). The reasoning policy may be learned through an embodied knowledge graph (S300) of the rationale dataset verified by the processor, and the rationale set learned through the rationale reconstruction loss based on the graph extracted through the knowledge graph retriever function may be generated (S310). In addition, the planning policy may be learned based on the rationale set of the learned reasoning policy and the planning policy reconstruction loss (S400). Thereafter, the SLM policy including the final reasoning policy and the planning policy may be generated based on the reasoning policy and the planning policy learned by the processor (S500).

According to another embodiment of the policy generating method for SLM, the processor may generate a rationale dataset based on the received expert dataset and the pre-stored initial rationale set (S100), and verify the rationale dataset through a self-verification function (S200). The reason dataset verified by the processor may be trained on the reasoning policy through the prompted KG (S305), and the planning policy may be trained on the rationale of the rationale set of the trained reasoning policy and the planning policy reconstruction loss (S400). Thereafter, the SLM policy including the final reasoning policy and the planning policy may be generated based on the reasoning policy and the planning policy learned by the processor (S500).

It will be understood by those skilled in the art that various modifications and variations can be made to the embodiments of the present invention without departing from the essential spirit and scope of the invention. Therefore, the disclosed embodiments should be considered illustrative rather than limiting. The scope of the invention is defined by the claims, and all equivalents falling within the scope of the claims shall be construed as being included in the invention.

What is claimed is:

1. A policy generating method for SLM, the method comprising:
receiving an expert dataset;
generating a rationale dataset based on the expert dataset and a pre-stored initial rationale set;
verifying the rationale dataset through a self-verification function;
learning a reasoning policy through an embodied knowledge graph based on the verified rationale dataset;
learning a planning policy based on a rationale set of the learned reasoning policy and a planning policy reconstruction loss; and
generating an SLM policy including a final reasoning policy and a planning policy based on the learned reasoning policy and the planning policy.

2. The policy generating method for SLM of claim 1,
wherein the learning a planning policy comprises generating the rationale set of the inferred reasoning policy based on a policy of an encoder based on an encoder prompt pool, a policy of a decoder based on a decoder prompt pool, and an attention module while performing the learning of the reasoning policy.

3. The policy generating method for SLM of claim 2,
wherein the encoder prompt pool comprises a prefix prompt and a postfix prompt.

4. The policy generating method for SLM of claim 2,
wherein the rationale set of the inferred reasoning policy is generated through rationale reconstruction loss based on a graph extracted through a rationale and a knowledge graph retriever function.

5. The policy generating method for SLM of claim 4,
wherein the rationale reconstruction loss is an equation
$${L}_{R t n} = {𝔼}_{( o , h , R ) ∼ {D}_{R t n}} [ {\sum }_{i = 1}^{m} log {Φ}_{R} ( {r}_{i} \vert g ) ]$$
(where, L_{Rtn} rationale reconstruction loss, o: observation, h: task description, R:
rationale set, g: graph extracted through knowledge graph retriever function).

6. The policy generating method for SLM of claim 1,
wherein the embodied knowledge graph is a prompted knowledge graph in the learning a reasoning policy.

7. The policy generating method for SLM of claim 6,
wherein the prompted knowledge graph is based on a batch sample including a positive pair, which is an embodied knowledge graph executing the same plan, and a negative pair, which is a continuous planning step.

8. The policy generating method for SLM of claim 6,
wherein the prompted knowledge graph is based on a contrastive learning loss, and the contrastive learning loss is an equation
$${L}_{C o n} = {𝔼}_{{B}_{C o n} ∼ {D}_{R t n}} [ max \{ 0 , d ( \hat{z} , {\hat{z}}^{+} ) - d ( \hat{z} , {\hat{z}}^{-} ) + ϵ \} ]$$
(where, L_{Con}: contrastive learning loss, B_{Con}: batch sample, \hat{z}: embedding space, d: sum of distance metrics corresponding to elements of each rationale embedding sequence within embedding space \hat{z}eεZ, and ϵ: margin parameter).

9. The policy generating method for SLM of claim 1,
wherein the planning policy is learned by predicting a next plan (a) based on the rationale set of the learned reasoning policy in the learning a planning policy, and learned through an equation
$${Φ}_{P} = ( R = {Φ}_{R} ( g ) ) \to a$$
(where, Φ_{P}: planning policy, R: rationale set of reasoning policy, Φ_{R}: reasoning policy, g: graph extracted through knowledge graph retriever function, a: next plan).

10. The policy generating method for SLM of claim 1,
wherein the planning policy reconstruction loss is an equation
$${L}_{P l a n} = {𝔼}_{( o , h , R ) ∼ {D}_{R t n} , R ∼ {Φ}_{R}} [ log {Φ}_{P} ( a \vert R ) ]$$
(where, L_{Plan}: planning policy reconstruction loss, o: observation, h: task description, R: rationale set, Φ_{P}: planning policy, a: next plan).

11. A policy generating apparatus for SLM, the apparatus comprising:
an input/output interface configured to receive an expert dataset;
a processor configured to generate an SLM policy based on the expert dataset; and
a communicator configured to transmit the generated SLM policy to a terminal,
wherein the processor is configured to generate a rationale dataset based on the expert dataset and a pre-stored initial rationale set, verify the rationale dataset through a self-verification function; learn a reasoning policy through an embodied knowledge graph based on the verified rationale dataset; learn a planning policy based on a rationale set of the learned reasoning policy and a planning policy reconstruction loss; and generate an SLM policy including a final reasoning policy and a planning policy based on the learned reasoning policy and the planning policy.

12. The policy generating apparatus for SLM of claim 11,
wherein the processor is further configured to, when learning the planning policy, generate the rationale set of the inferred reasoning policy based on a policy of an encoder based on an encoder prompt pool, a policy of a decoder based on a decoder prompt pool, and an attention module while performing the learning of the reasoning policy, and
wherein the encoder prompt pool comprises a prefix prompt and a postfix prompt.

13. The policy generating apparatus for SLM of claim 12,
wherein the processor is further configured to generate the rationale set of the inferred reasoning policy through rationale reconstruction loss based on a graph extracted through a rationale and a knowledge graph retriever function.

14. The policy generating apparatus for SLM of claim 13,
wherein the rationale reconstruction loss is an equation
$${L}_{R t n} = {𝔼}_{( o , h , R ) ∼ {D}_{R t n}} [ {\sum }_{i = 1}^{m} log {Φ}_{R} ( {r}_{i} \vert g ) ]$$
(where, L_{Rtn} rationale reconstruction loss, o: observation, h: task description, R: rationale set, g: graph extracted through knowledge graph retriever function).

15. The policy generating apparatus for SLM of claim 11, wherein the embodied knowledge graph is a prompted knowledge graph in the learning a reasoning policy.

16. The policy generating apparatus for SLM of claim 15,
wherein the prompted knowledge graph is based on a batch sample including a positive pair, which is an embodied knowledge graph executing the same plan, and a negative pair, which is a continuous planning step.

17. The policy generating apparatus for SLM of claim 15,
wherein the prompted knowledge graph is based on a contrastive learning loss, and the contrastive learning loss is an equation
$${L}_{C o n} = {𝔼}_{{B}_{C o n} ∼ {D}_{R t n}} [ max \{ 0 , d ( \hat{z} , {\hat{z}}^{+} ) - d ( \hat{z} , {\hat{z}}^{-} ) + ϵ \} ]$$
(where, L_{Con}: contrastive learning loss, B_{Con}: batch sample, \hat{z}: embedding space, d: sum of distance metrics corresponding to elements of each rationale embedding sequence within embedding space \hat{z}εZ, and ϵ: margin parameter).

18. The policy generating apparatus for SLM of claim 11,
wherein the planning policy is learned by predicting a next plan (a) based on the rationale set of the learned reasoning policy in the learning a planning policy, and learned through an equation
$${Φ}_{P} = ( R = {Φ}_{R} ( g ) ) \to a$$
(where, Φ_{P}: planning policy, R: rationale set of reasoning policy, Φ_{R}: reasoning policy, g: graph extracted through knowledge graph retriever function, a: next plan).

19. The policy generating apparatus for an SLM of claim 11,
wherein the planning policy reconstruction loss is an equation
$${L}_{P l a n} = {𝔼}_{( o , h , R ) ∼ {D}_{R t n} , R ∼ {Φ}_{R}} [ log {Φ}_{P} ( a \vert R ) ]$$
(where, L_{Plan}: planning policy reconstruction loss, o: observation, h: task description, R: rationale set, Φ_{P}: planning policy, a: next plan).

20. A central server for generating a policy for an SLM, the central server comprising:
an input/output interface configured to receive an expert dataset;
a processor configured to generate an SLM policy based on the expert dataset; and
a communicator configured to transmit the generated SLM policy to a terminal,
wherein the processor is configured to generate a rationale dataset based on the expert dataset and a pre-stored initial rationale set, verify the rationale dataset through a self-verification function; learn a reasoning policy through an embodied knowledge graph based on the verified rationale dataset; learn a planning policy based on a rationale set of the learned reasoning policy and a planning policy reconstruction loss; and generate an SLM policy including a final reasoning policy and a planning policy based on the learned reasoning policy and the planning policy.
